(19) United States
(12) Patent Application Publication
(10) Pub. No.: US 2012/0223662 A1
(43) Pub. Date: Sep. 6, 2012

(54) MOTOR SPEED CONTROL SYSTEM

(75) Inventor: Miu Kwan Cheuk, Hong Kong (HK)

(73) Assignee: KING GOLDEN LIMITED, HONG KONG (HK)

(21) Appl. No.: 13/040,285

(22) Filed: Mar. 4, 2011

(51) Int. Cl. H02P 1/00

(52) U.S. Cl. 318/139

(57) ABSTRACT

This present utility involves a motor control system which can be connected with Wi-Fi and Bluetooth. It comprises of a motor, a power supply and a cooling fan, wherein the power supply, the motor and the control circuit board are connected with the cooling fan. There is also a speed control circuit connected with the cooling fan, wherein there is a mode of Wi-Fi and/or Bluetooth in the control circuit, of which it can connect with all kinds of device which has mode of Wi-Fi and/or Bluetooth. This present utility can connect with electronic devices via Wi-Fi and/or Bluetooth for processing mode conversion thereof.

### FIELD OF TECHNOLOGY

The present utility model involves a control system, particularly is a motor speed control system which can be connected with Wi-Fi and Bluetooth.

### BACKGROUND OF THE TECHNOLOGY

Currently, the control system for motors of toys, e.g. remote control cars, airplanes, boats, etc., when it is necessary to be controlled, the toy shell must be opened and the mode conversion control is set in a built-in operating mode button. Besides, there is only a small light flashing to indicate the confirmation of mode conversion or there is a small display which showing the default number of mode conversion but without conversion details. Once the mode conversed to a kind of default situation, the playability will be reduced.

There is a prior art which is a control system and can be connected by USB with iphone handheld, ipod players, etc., of which the mode can be conversed by its operating software. Although it is an advance model from the traditional mode conversion, but it is still subject to cable and hence it is not flexible. Nowadays, most of the electronic devices have mode of Wi-Fi and/or Bluetooth, therefore it is more convenient by using them to process data exchange.

### SUMMARY OF THE UTILITY MODEL

The purpose of the present invention is to provide a motor control system which can connect with electronic devices, such as iphone handheld, ipod players, PMP, MP4 and GPS, etc., by Wi-Fi and/or Bluetooth for processing mode conversion thereof.

The present invention comprising of a motor, a power supply and a cooling fan, wherein the power supply, the motor and the control circuit board are connected with the cooling fan, characteristic in that there is also a button for mode operation and a speed control circuit connected with the cooling fan, wherein there is a mode of Wi-Fi and/or Bluetooth in the control circuit, of which it can connect with all kinds of device which has mode of Wi-Fi and/or Bluetooth.

The present invention can connect with electronic devices, such as iphone handheld, ipod players, PMP, MP4 and GPS, or devices with Window Mobile System etc., by Wi-Fi and/or Bluetooth for processing data connection. A wireless connection mode with Wi-Fi and/or Bluetooth is formed. Users can change all kinds of operating mode such as sports mode, acceleration, reversal throttle limitation etc. with these electronic devices easily for increasing fun of playing.

### DESCRIPTION OF DRAWINGS

FIG. 1 is the schematic diagram for the motor control system provided by the embodiment of the present utility model.

### DESCRIPTION OF EMBODIMENT

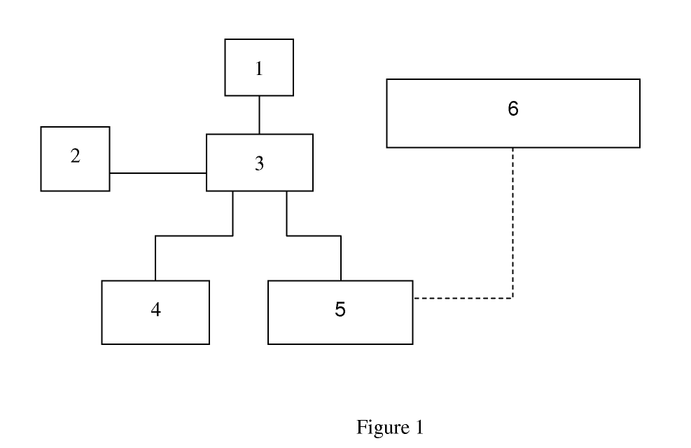

As shown in FIG. 1, in the embodiment of the present utility model, comprising of a power supply 1, a motor 2, a cooling fan 3, a switch of mode conversion 4, a control circuit board 5, wherein the power supply 1, the motor 2, the switch mode of conversion 4 are connected with the cooling fan 3, and the cooling fan 3 is connected with the control circuit board 5, wherein there is a mode of Wi-Fi and/or Bluetooth in the control circuit board 5, of which the present utility can connect with all kinds of electronic device 6 which has mode of Wi-Fi and/or Bluetooth.

The electronic device 6 as mentioned can be an iphone handheld, ipod players, PMP, MP4 and GPS, or devices with Window Mobile System etc. which has mode of Wi-Fi and/or Bluetooth.

The present utility can be loaded into any kind of remote control toys, such as remote control car, remote control airplanes, etc. By using any kind of electronic device 6, for example an iphone handheld, the present utility can be connected with the iphone by Wi-Fi and/or Bluetooth for data connection, and then users can control the motor 2 of the remote control car or remote control airplane via the iphone. Besides, the mode can also be conversed by using the built-in software of the electronic device 6, and display the details of mode conversion in the display screen of the electronic device 6. Furthermore, the mode can also be conversed by using the switch mode 4 manually.

It shall be noted that, the abovementioned embodiment is only applied to illustrate, but not limit, the technical solution of the present invention. Although the present invention is detailed by referring to the preferred embodiment, those skilled in the art shall understand that the revisions or equivalent replacements to the technical solution without deviating from the spirit or scope of the technical solution of the present invention shall be within the scope defined by the claims for the present invention.

What is claimed is:

1. A motor control system which can be connected with Wi-Fi and Bluetooth, comprising of a power supply, a motor , a cooling fan;
the power supply, the motor and the control circuit board are connected with the cooling fan;
there is also a speed control circuit connected with the cooling fan;
there is also a mode of Wi-Fi and/or Bluetooth in this control circuit board;
the present utility can connect with all kinds of electronic device which has mode of Wi-Fi and/or Bluetooth.

2. A motor control system as in claim 1, there is also a button which is connected with the cooling fan for mode operation conversion.
